(19) United States
(12) Patent Application Publication
(10) Pub. No.: US 2025/0050857 A1
(43) Pub. Date: Feb. 13, 2025

(54) METHOD FOR OPERATING A BRAKE SYSTEM OF A UTILITY VEHICLE

(71) Applicants: ZF Friedrichshafen AG, Friedrichshafen (DE); ZF CV Systems Europe BV, Brussels (BE)

(72) Inventors: Martin Sagmeister, Passau (DE); Michael Haverkamp, Hannover (DE)

(73) Assignees: ZF Friedrichshafen AG, Friedrichshafen (DE); ZF CV Systems Europe BV, Brussels (BE)

(21) Appl. No.: 18/694,730

(22) PCT Filed: Aug. 15, 2022
(86) PCT No.: PCT/EP2022/072748

§ 371 Date: Mar. 22, 2024

(30) Foreign Application Priority Data
Sep. 24, 2021 (DE) 10 2021 210 697.8

(51) Int. Cl. B60T 13/58; B60T 7/12; B60T 8/171; B60T 8/172; B60T 13/66; B60T 13/74

(52) U.S. Cl. CPC B60T 13/588; B60T 7/12; B60T 8/171; B60T 8/172; B60T 13/662; B60T 13/745; B60T 2270/402; B60T 2270/403; B60T 2270/406

(57) ABSTRACT

A method is provided for operating a brake system of a commercial vehicle having a service brake system, an auxiliary brake system, and braking devices for vehicle wheels. At least one associated service brake actuator is actuated in the service brake system in normal operation when a brake actuating device is actuated, via which a respective associated braking device is actuated. In the auxiliary brake system, a control unit actuates at least one braking device. In the auxiliary brake system, the control unit actuates the at least one braking device by activating at least one auxiliary brake actuator, where the auxiliary brake actuator is accessed by the control unit during emergency operation when actuating the at least one brake actuating device is detected. In this case, the control unit uses the auxiliary brake actuator to set actuation of the at least one braking device to a degree of actuation.

### RELATED APPLICATIONS

This application claims the benefit under 35 U.S.C. § 371 as a U.S. National Phase Application of application no. PCT/EP2022/072748, filed on 15 Aug. 2022, which claims the benefit of German Patent Application no. 10 2021 210 697.8, filed on 24 Sep. 2021, the contents of which are hereby incorporated herein by reference in their entireties.

### FIELD OF THE DISCLOSURE

The invention relates to a method for operating a brake system of a commercial vehicle, in particular an agricultural or municipal commercial vehicle, wherein the brake system has a service brake system, an auxiliary brake system and braking devices for vehicle wheels of the commercial vehicle, wherein in the service brake system in normal operation at least one associated service brake actuator is actuated when at least one brake actuating device is actuated, via which an actuation of the respectively associated braking device corresponding to the actuation of the at least one brake actuating device is carried out with control, wherein in the auxiliary brake system an actuation of at least one of the braking devices can be initiated via at least one control unit, and wherein an emergency operation is carried out when an at least partial failure of the service brake system is detected. The invention also relates to a control unit, a brake system of a commercial vehicle and a commercial vehicle.

### BACKGROUND

Brake systems of motor vehicles usually have a service brake system in order to be able to brake vehicle wheels and thus also the motor vehicle while the respective motor vehicle is in motion by correspondingly actuating one or more associated brake actuating devices. In addition, an auxiliary brake system is usually provided in a brake system, by means of which the respective motor vehicle can be held in its current position when stationary, for example when parked, by firmly braking at least individual vehicle wheels. A brake system in a motor vehicle must be implemented as a redundant system in order to enable the vehicle to be braked even if one part of the brake system fails. In some cases, the auxiliary brake system is specifically called upon in the event of at least partial failure of the service brake system in order to be able to brake the vehicle.

US 2005/0168064 A1 describes a brake system for a commercial vehicle which is a towing vehicle, such as a semi-trailer truck. The brake system comprises a service brake system and an auxiliary brake system, which can be used to brake the vehicle wheels of the commercial vehicle independently of each other via braking devices. The brake system of US 2005/0168064 A1 is realized as an electronic brake system in which, on the one hand, an actuation of a brake actuating device of the service brake system in the form of a brake pedal and, on the other hand, an actuation of a parking brake actuating device of a parking brake system in the form of a handbrake lever are each detected via control units and converted into corresponding actuations of brake actuators in a data bus system. Brake actuators of a front axle of the commercial vehicle and brake actuators of a rear axle of the commercial vehicle are integrated in separate circuits.

In the event of a partial failure of the service brake system in the form of a failure of the brake circuit of the front axle, the vehicle wheels of the front axle are braked by other means as part of emergency operation. In one variant, an actuation of the parking brake actuating device in the auxiliary brake system is converted into braking of the vehicle wheels of the front axle via the brake actuators during emergency operation, for which purpose a control unit activates a valve and the brake actuators of the front axle are supplied with fluid from a circuit for a trailer of the commercial vehicle that is independent of the brake circuit of the front axle.

### SUMMARY

Based on the state of the art described above, it is now the task of the present invention to create a brake system for a commercial vehicle by means of which reliable braking of the commercial vehicle can nevertheless be carried out in the event of at least partial failure of a service brake system, while at the same time enabling a simple design of this brake system.

From a process engineering point of view, this problem is solved by methods as variously disclosed in the present disclosure, in conjunction with the characterizing features. From the point of view of device technology, the task is solved by the technical features of a control unit for a brake system. In another aspect, a brake system for a commercial vehicle includes a control unit as discussed above. Finally, the present disclosure relates to a commercial vehicle with a brake system as described above. The present disclosure provides advantageous further embodiments of the invention.

According to one example, in a method for operating a brake system which has a service brake system, an auxiliary brake system and braking devices for vehicle wheels of the commercial vehicle, at least one associated service brake actuator is actuated in the service brake system in normal operation when at least one brake actuating device is actuated, via which actuator an actuation of the respectively associated braking device corresponding to the actuation of the at least one brake actuating device is carried out with actuation. Furthermore, at least one control unit can be used to initiate actuation of at least one of the braking devices in the auxiliary brake system. If at least a partial failure of the service brake system is detected, emergency operation is also carried out.

The method according to the invention is used in a brake system of a commercial vehicle, which is in particular an agricultural or municipal commercial vehicle. The utility vehicle is preferably an agricultural tractor. The commercial vehicle preferably has several axles in the form of a front axle and a rear axle, of which at least one axle is equipped with brakeable vehicle wheels. However, it is particularly preferable that all vehicle wheels can be braked, for which purpose a braking device is assigned to each vehicle wheel. In the context of the invention, a braking device for a vehicle wheel is in particular a disc brake, which can be designed as a wet multi-disc brake.

In the context of the invention, each braking device is preferably assigned to a service brake actuator, which is used to actuate the associated braking device when activated. This actuation is carried out in normal operation of the brake system when an actuation takes place on at least one brake actuating device of the service brake system, wherein an intensity of an actuation of the respective braking device takes place via the associated service brake actuator as a function of an intensity of the actuation of the at least one brake actuating device. Within the meaning of the invention, the at least one brake actuating device is present in particular as a brake pedal, which can be actuated by a driver of the commercial vehicle to brake the commercial vehicle via the service brake system.

The brake system within the scope of the invention can have exactly one brake actuating device, the actuation of which in normal operation of the brake system activates all service brake actuators of the service brake system and accordingly also brakes the vehicle wheels via the associated braking devices. However, two brake actuating devices are particularly preferred in order to be able to reproduce the function of a steering brake via the service brake system. Thus, by actuating one brake actuating device, only the service brake actuator or actuators, which actuate the braking devices located on one side of the commercial vehicle in the longitudinal direction of the commercial vehicle, are actuated, while actuating the other brake actuating device results in actuation of the braking devices located on the other side of the commercial vehicle by actuating the service brake actuator or actuators located here.

In the brake system, the auxiliary brake system is intended to brake the vehicle according to the driver's instructions in the event of at least partial failure of the service brake system. The auxiliary brake system is also particularly preferably designed to implement a parking brake function of the commercial vehicle in normal operation of the brake system in response to a corresponding command from the vehicle driver in order to hold the commercial vehicle in a current position by applying the brakes on the vehicle wheels. In the method according to the invention for operating the brake system, this parking brake function is realized in that an actuation of at least one of the braking devices of the vehicle wheels is initiated via the at least one control device. It is particularly preferable for the at least one control unit to initiate this actuation as part of the parking brake function if a corresponding specification has been made by a vehicle driver on an actuating device. In particular, this actuating device is a device on which the vehicle driver can make a stepless setting, such as a brake lever.

As part of the method according to the invention, an emergency operation of the brake system is carried out if an at least partial failure of the service brake system has been detected. If it is therefore recognized that the service brake system of the brake system is not working properly, in particular if pressure is not built up in the brake system or only to an insufficient extent, the system switches to emergency operation. In accordance with the invention, this is preferably carried out from a degree of failure of the service brake system above which there is a risk of insufficient braking of the commercial vehicle.

The invention now comprises the technical teaching that, in the auxiliary brake system, the actuation of the at least one braking device is initiated via the at least one control unit by activating at least one auxiliary brake actuator. In the course of emergency operation, the auxiliary brake actuator is accessed by the at least one control device by detecting the actuation of the at least one brake actuating device, wherein the at least one control device uses the auxiliary brake actuator to set an actuation of the at least one braking device based on the degree of actuation of the at least one brake actuating device.

In other words, in the auxiliary brake system of the brake system, the at least one braking device is actuated by the at least one control unit actuating at least one auxiliary brake actuator. During emergency operation, the at least one control unit also activates the auxiliary brake actuator if an actuation of the at least one brake actuating device of the service brake system has been detected, i.e., if there is a command from the driver to brake the commercial vehicle. However, since this request cannot be implemented via the service brake system or only to an insufficient extent due to the at least partial failure of the service brake system, the at least one control unit now controls the auxiliary brake actuator in such a way that the actuation of the at least one braking device via the auxiliary brake actuator is modeled on the intensity of the actuation of the at least one brake actuating device of the service brake system.

Such a method of operating a brake system has the advantage that even if the service brake system of the brake system fails at least partially, the auxiliary brake system can still be used to bring about at least approximately sufficient braking of the commercial vehicle. This means that if the service brake system fails, the driver can still brake the commercial vehicle and bring it to a standstill. This takes place automatically and without additional action by the driver, in that the at least one control unit in emergency mode automatically actuates the at least one braking device by accessing the auxiliary brake actuator when the actuation of the at least one brake actuating device is detected. Since the auxiliary brake actuator is controlled via the at least one control unit, a simple brake system design can also be realized at the same time. This makes it possible to achieve electronic actuation of the at least one auxiliary brake actuator of the auxiliary brake system, which means that hydraulic/pneumatic components can be dispensed with, at least to a large extent.

Preferably, the same vehicle wheels can be braked via the auxiliary brake system by means of the one auxiliary brake actuator or the multiple auxiliary brake actuators that can also be braked via the service brake system. In this respect, the at least one auxiliary brake actuator within the auxiliary brake system has access to the same braking devices in particular. In particular, two associated braking devices for vehicle wheels of a vehicle axle are actuated via an auxiliary brake actuator when activated via the at least one control unit.

In US 2005/0168064 A1, the braking devices in the auxiliary brake system are also actuated via a control unit of the auxiliary brake system, in that this control unit actuates brake actuators electronically. In emergency mode, however, no independent actuation of the brake actuators is initiated via the control unit in accordance with the specifications on the brake pedal; instead, in a variant of US 2005/0168064 A1, the brake actuators of the front axle of the commercial vehicle are supplied from a brake circuit for a trailer of the commercial vehicle in accordance with the specifications on the handbrake lever of the parking brake. In addition, the same brake actuators are assigned to the auxiliary brake system and the service brake system.

In terms of the invention, in the method for operating a brake system according to the invention, activation of the at least one auxiliary brake actuator via the at least one control device is preferably realized by electronic access of the control device to the auxiliary brake actuator, wherein the at least one control device can directly access the at least one auxiliary brake actuator electronically within the scope of the invention or activation and thus access can take place via intermediate components, for example further control devices and/or electronic components. The auxiliary brake actuator also functions particularly preferably as a parking brake actuator, i.e., the brake actuator of the auxiliary brake system is also used to perform parking braking of the vehicle as part of a firm braking function. In particular, the auxiliary brake actuator comprises a spring brake cylinder.

In the sense of the invention, the fact that in emergency mode an actuation of the at least one braking device is “oriented” via the at least one control unit to a degree of actuation of the at least one brake actuating device means that such an actuation of the at least one braking device is initiated via the auxiliary brake actuator via the at least one control unit, which corresponds as closely as possible to a specification on the at least one brake actuating device of the service brake system. As part of the method according to the invention, an attempt is therefore made during emergency operation via the control unit to compensate as far as possible for the at least partial failure of the service brake system and to implement the driver's instructions on the at least one brake actuating device with regard to braking the commercial vehicle as far as possible. Particularly preferably, the at least one control device is used to actuate the at least one braking device by means of the auxiliary brake actuator, which corresponds to the specification on the at least one brake actuating device.

As part of the method according to the invention, a corresponding warning message is also preferably issued when the at least partial failure of the service brake system is detected and thus at the start of emergency operation, in order to alert the driver of the commercial vehicle to the at least partial failure of the service brake system. This warning message can be in the form of a visual and/or audible warning.

According to one embodiment of the invention, a required braking torque is determined in the course of emergency operation based on the degree of actuation of the at least one brake actuating device, the required braking torque then being used to set the actuation of the at least one auxiliary brake actuator. During emergency operation, the braking torque to be set on the braking devices is therefore determined on the basis of the driver's specification on the at least one brake actuating device. This required braking torque is then used to adjust the control of the at least one auxiliary brake actuator in order to at least substantially generate the required braking torque via the at least one auxiliary brake actuator on the associated braking devices. Particularly preferably, the required braking torque is also determined by the at least one control device, wherein the at least one control device is supplied with information about the degree of actuation of the at least one brake actuating device for this purpose. In particular, the at least one control unit exchanges data for this purpose with a sensor system that detects the degree of actuation of the at least one brake actuating device.

According to one possible embodiment of the invention, an at least partial failure is detected as an at least insufficient pressure supply to the at least one associated service brake actuator via a pressure source to which the at least one associated service brake actuator is connected when the actuation of the at least one brake actuating device is detected. If it is therefore detected that there is no pressure supply or that the pressure supply to the respective service brake actuator in the service brake system is too low to display the required braking torque, the system switches to emergency mode and the auxiliary brake actuator is actuated automatically via the at least one control unit. The at least one associated service brake actuator and the pressure source are preferably integrated in a brake circuit of the service brake system, wherein, depending on the type of actuator, this can be a hydraulic or pneumatic brake circuit in which the actuator can be supplied with hydraulic fluid or compressed air.

In a further development of the aforementioned design option, the pressure supply in the service brake system, which is at least too low, is detected via a sensor system, which is preferably a pressure sensor. This provides a simple way of detecting if the pressure supply is too low.

It is an embodiment of the invention that the activation of the at least one auxiliary brake actuator is initiated via a first control unit, which is in particular a brake control unit. For this purpose, data is transmitted between the first control unit and a second control unit in a data transmission system, wherein the second control unit can be a transmission control unit. The auxiliary brake actuator is then controlled via the second control unit in accordance with a specification from the first control unit. In an advantageous manner, this allows indirect activation of the at least one auxiliary brake actuator via the first control unit by communicating with the second control unit, which then implements the specifications of the first control unit by directly activating the auxiliary brake actuator.

In a further development of the invention, the at least one braking device is actuated in the auxiliary brake system by relieving the pressure in the at least one auxiliary brake actuator in each case from a fluid cylinder which is equipped with an actuating piston preloaded into an actuating position. In this respect, the at least one braking device is actuated via the at least one auxiliary brake actuator when the respective fluid cylinder of the auxiliary brake actuator is depressurized. For this purpose, the respective fluid cylinder is designed as an inverse fluid cylinder.

For this purpose, the actuating piston of the fluid cylinder is preloaded into an actuating position, wherein the actuating piston is transferred into an open position by pressurizing the fluid cylinder with fluid, in which the actuation of the at least one braking device via the auxiliary brake actuator is canceled. Accordingly, if the respective fluid cylinder of the auxiliary brake actuator is supplied with fluid depending on the pressure, actuation of the at least one braking device is reduced or even canceled, while if there is no fluid supply and the associated pressure relief due to the preload of the actuating piston, actuation of the at least one braking device takes place via the auxiliary brake actuator.

Particularly preferably, at least one valve is also provided in the auxiliary brake system, via which a pressure of the supply of the respective fluid cylinder of the at least one auxiliary brake actuator can be set. This is necessary in the context of the invention in order to also adjust the actuation of the at least one braking device via the auxiliary brake actuator by controlling the pressure. This is because a controlled actuation of the at least one braking device via the auxiliary brake actuator is necessary to realize emergency operation. A proportional valve or a combination of several valves can be used to set the pressure.

Another object of the invention is a control device which is set up to initiate activation of at least one auxiliary brake actuator in an auxiliary brake system of a commercial vehicle in order to actuate at least one braking device for each vehicle wheel. Furthermore, the control device is designed to initiate an emergency operation when an at least partial failure of a service brake system of the brake system is detected, to access the at least one auxiliary brake actuator in the course of the emergency operation with detection of an actuation of at least one brake actuating device of the service brake system and to initiate an actuation of the at least one braking device via the auxiliary brake actuator oriented to a degree of actuation of the at least one brake actuating device.

Such a design of a control unit and its use in a brake system of a commercial vehicle has the advantage that, in the event of an at least partial failure of the service brake system of the brake system, the at least one auxiliary brake actuator of the auxiliary brake system can be accessed independently via the control unit in order to subsequently bring about braking by actuating at least one braking device via the auxiliary brake actuator, which is oriented to a specification of a vehicle driver via at least one brake actuating device. This can also be realized with a compact design by direct or indirect electronic access of the control unit to the at least one auxiliary brake actuator. In particular, the control unit is a brake control unit of the brake system.

Furthermore, the control device according to the invention is then preferably designed in such a way that a method for operating a brake system according to one or more of the variants described above can be realized.

An aforementioned control device is preferably part of a brake system for a commercial vehicle, this brake system comprising a service brake system, an auxiliary brake system, braking devices for vehicle wheels of the commercial vehicle and at least the control device according to the invention. The service brake system has at least one brake actuating device, via which at least one associated service brake actuator can be actuated when actuated in normal operation, wherein the at least one associated service brake actuator actuates the respective associated braking device corresponding to the actuation of the at least one brake actuating device when actuated in normal operation. Furthermore, the auxiliary brake system has an auxiliary brake actuator that can be controlled via the control unit and actuates at least one of the braking devices when activated.

As described above, the control device according to the invention then accesses the auxiliary brake actuator in the event of an at least partial failure of the service brake system by detecting the actuation of the at least one brake actuating device and, in doing so, actuates the at least one braking device via the auxiliary brake actuator based on the degree of actuation of the at least one brake actuating device. A reliable brake system for a commercial vehicle can thus be realized, in which even in the event of an at least partial failure of the service brake system, the commercial vehicle can be braked via the control unit and thus without the active action of a vehicle driver in response to a command from the vehicle driver. The brake system of the commercial vehicle can be operated in the manner described above as part of the method according to the invention.

In the aforementioned brake system, a first control unit and a second control unit can be provided, which are connected to each other in a data transmission system, preferably a CAN bus. While the first control unit is in particular a brake control unit, the second control unit can be a transmission control unit of a transmission, which is arranged in the area of an axle of the commercial vehicle. The second control unit can be used to control the auxiliary brake actuator. If the second control unit is a transmission control unit, this is particularly the case if the auxiliary brake actuator is located in the transmission area or even integrated into it.

In a further development of a brake system, the auxiliary brake actuator has a fluid cylinder with an actuating piston that is preloaded into an actuating position. By pressurizing the fluid cylinder with fluid, the actuating piston can be transferred to an open position in which the actuation of the at least one braking device via the auxiliary brake actuator is cancelled. Accordingly, the fluid cylinder of the respective auxiliary brake actuator is designed as an inverse fluid cylinder, in that actuation of the at least one braking device is reduced or canceled via the fluid cylinder when pressure is supplied as a function of a pressure, whereas the fluid cylinder causes actuation of the at least one braking device when there is no pressure supply.

In the service brake system of the brake system, the at least one associated service brake actuator is arranged in one brake circuit each, in which, during normal operation of the brake system, the associated service brake actuator is controlled as a function of the actuation of the at least one brake actuating device. Preferably, the one brake circuit is designed as a hydraulic circuit in which fluid in the form of hydraulic fluid is provided. The service brake actuators are then designed as hydraulic actuators. Alternatively, the fluid in the brake circuit can also be in the form of compressed air, in which case the components and the service brake actuators in the brake circuit are pneumatic components.

A valve plate can also be provided in the brake circuit, via which an actuation of the at least one brake actuating device is converted into corresponding pressures for controlling the service brake actuators by means of corresponding valves during normal operation of the brake system.

Alternatively, but preferably in addition to the aforementioned variant, a sensor system can be provided in at least one brake circuit in which the service brake actuators can be controlled, via which a fluid pressure of the at least one brake circuit can be monitored. This sensor system can be used to detect at least partial failure of the service brake system if the service brake actuators are not supplied with power or only to an insufficient extent. The sensor system is preferably formed by a pressure sensor, by means of which a fluid pressure in the at least one brake circuit can be determined. Such a pressure sensor can be provided on a valve block of the at least one brake circuit.

The invention also relates to a commercial vehicle in which a brake system corresponding to one or more of the aforementioned variants is provided. The commercial vehicle is preferably an agricultural or municipal commercial vehicle and in particular a farm tractor.

The invention is not limited to the specified combination of the subsidiary claims or claims dependent thereon. Individual features can also be combined with one another, including those that emerge from the claims, the following description of a preferred embodiment of the invention or directly from the drawings. References in the claims to the drawings by means of reference signs is not intended limit the scope of protection of the claims.

### BRIEF DESCRIPTION OF THE DRAWINGS

Advantageous embodiments of the invention are discussed with reference to the drawings:

FIG. 1 is a schematic view of a brake system of a commercial vehicle, according to a preferred embodiment of the invention;

FIG. 2 is an illustration of the brake system from FIG. 1, shown in normal operation and in a first actuation state;

FIG. 3 is an illustration of the brake system of FIG. 1, shown in normal operation and in a second actuation state; and

FIG. 4 is an illustration of the brake system from FIG. 1, shown in emergency operation.

### DETAILED DESCRIPTION

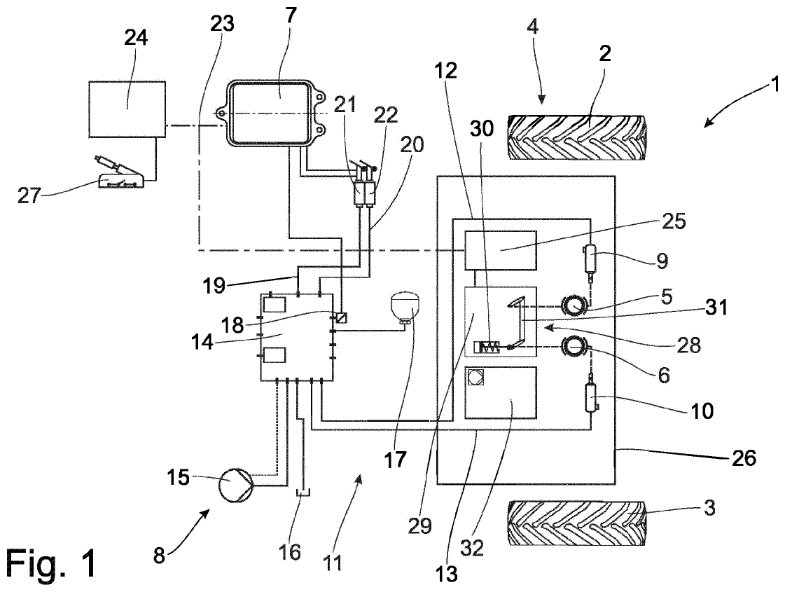

FIG. 1 shows a schematic view of a brake system 1 of a commercial vehicle, in particular an agricultural commercial vehicle in the form of a farm tractor. The brake system 1 is designed in accordance with a preferred embodiment of the invention and is used to brake vehicle wheels 2 and 3 of a vehicle axle 4 of the commercial vehicle, which in the present case is a rear axle of the commercial vehicle. Within the brake system 1, however, a further vehicle axle, in particular a front axle of the commercial vehicle, with brakeable vehicle wheels can also be provided within the scope of the invention, wherein this further vehicle axle can be equipped in an analogous manner with a brake system for braking the vehicle wheels.

Each of the vehicle wheels 2 and 3 is assigned a braking device 5 or 6 by the brake system 1, wherein the braking devices 5 and 6 are designed in the form of disc brakes. Specifically, the disc brakes may be wet multi-disc brakes. When actuated, the individual braking device 5 or 6 ensures that the associated vehicle wheel 2 or 3 is braked or locked.

The brake system 1 according to the invention comprises a control unit 7 in the form of a brake control unit and a service brake system 8. Two service brake actuators 9 and 10 with hydraulic fluid cylinders are provided within the service brake system 8, wherein the service brake actuator 9 actuates the braking device 5 when pressure is applied and the service brake actuator 10 actuates the braking device 6 when pressure is applied. Here, in a manner known in principle to the skilled person, when the respective fluid cylinder of the service brake actuator 9 or 10 is supplied with hydraulic fluid, a displacement of a respective piston is caused, which is coupled to the respective associated braking device 5 or 6, wherein this is preferably realized via a respective ball ramp. Accordingly, when the piston of the respective fluid cylinder is displaced due to the coupling, the associated braking device 5 or 6 is actuated.

The service brake actuators 9 and 10 are integrated into a hydraulic brake circuit 11 by being connected to a valve block 14 via lines 12 and 13. Also connected to this valve block 14 in the brake circuit 11 are a pressure source 15 in the form of a hydraulic pump of the commercial vehicle, a tank 16 for hydraulic fluid, a pressure accumulator 17, a pressure sensor 18 and two further lines 19 and 20. The pressure sensor 18 can be used to determine the prevailing supply pressure of the hydraulic fluid in the brake circuit 11.

In the present case, a brake actuating device 21 and 22 is connected to each of the lines 19 and 20, wherein the brake actuating devices 21 and 22 are each present as brake pedals via which a driver of the commercial vehicle can actuate the service brake actuators 9 and 10 of the service brake system 8. A degree of actuation of the respective brake actuating device 21 or 22 is detected by sensors and determined by the control unit 7. The control unit 7 also records the pressure in the brake circuit 11 determined by the pressure sensor 18.

As can be seen in FIG. 1, the control unit 7 is also connected to two other control units 24 and 25 in a data transmission system in the form of a CAN bus 23, of which the control unit 24 is a vehicle control unit and the control unit 25 is a transmission control unit of a transmission 26. The transmission 26 is positioned in the area of the vehicle axle 4.

Of the control units 24 and 25, the control unit 24 is connected to an actuating device 27 of an auxiliary brake system 28, wherein this actuating device 27 is present as a brake lever. An actuation position of this brake lever is detected via the control unit 24. The auxiliary brake system 28 is provided within the brake system 1 in normal operation to provide a parking brake function for the firm braking of the two vehicle wheels 2 and 3 in order to hold the commercial vehicle in a current position. During normal operation of the brake system 1, this firm braking takes place via the actuating device 27 if the driver gives the appropriate instructions.

For this purpose, the auxiliary brake system 28 is assigned an auxiliary brake actuator 29, which is integrated into the transmission 26 in the area of the vehicle axle 4. This auxiliary brake actuator 29 comprises a fluid cylinder 30, in which an actuating piston is preloaded via a spring element into an actuating position, in which the actuating piston acts on the two braking devices 5 and 6 via a bridge 31 and actuates them. The fluid cylinder 30 is supplied with hydraulic fluid from a pressure source 32 of the transmission 26 inversely to an actuation of the actuating device 27, so that in normal operation in a released state of the actuating device 27 a pressurization of the fluid cylinder 30 and thus a movement of the actuating piston against the spring element is initiated, whereby an actuation of the braking devices 5 and 6 via the auxiliary brake actuator 29 is cancelled. If, on the other hand, the actuating device 27 is actuated by the driver, the fluid cylinder 30 is increasingly relieved of pressure and thus, due to the effect of the spring element, the actuating piston of the fluid cylinder 30 also causes increasing actuation of the braking devices 5 and 6. In order to be able to set a degree of actuation, at least one valve—not shown here—is assigned to the auxiliary brake actuator 29, wherein this at least one valve is controlled via the control unit 25. The required degree of actuation is communicated to the control unit 25 within the CAN bus 23 by the control unit 24.

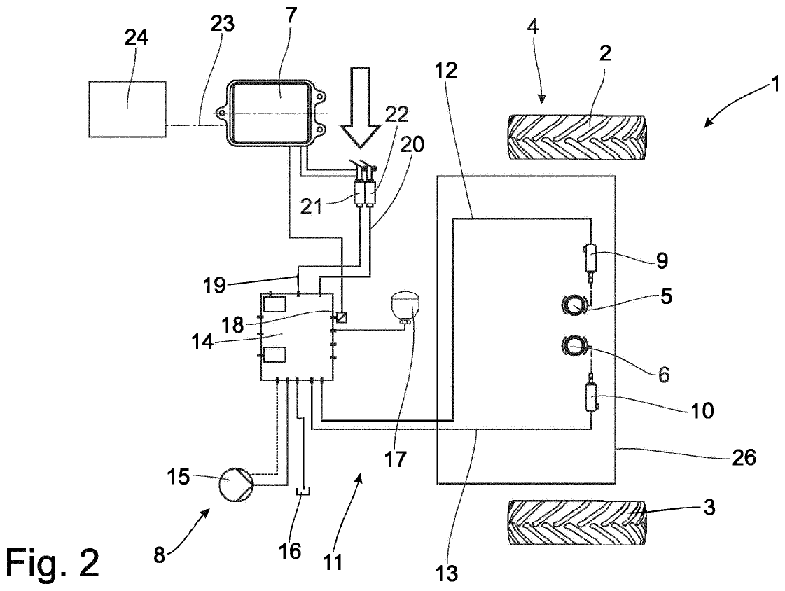

FIGS. 2 through 4 show different states of the brake system 1 from FIG. 1, wherein only the components currently actively participating in a braking process are shown. FIG. 2 shows a state of the brake system 1 when the service brake is used, wherein the brake actuating devices 21 and 22 are actuated by a vehicle driver. An actuation of the individual brake actuating device 21 or 22 on the valve block 14 is converted into an adjustment of a corresponding pressure in the lines 12 and 13. The service brake actuators 9 and 10 subsequently actuate the two braking devices 5 and 6, so that the vehicle wheels 2 and 3 are braked accordingly. The driver can also actuate the brake actuating devices 21 and 22 differently, or even just one of the brake actuating devices 21 or 22, in order to realize the function of a commercial vehicle steering brake by actuating them more strongly on one side or only on one side and via one of the braking devices 9 or 10.

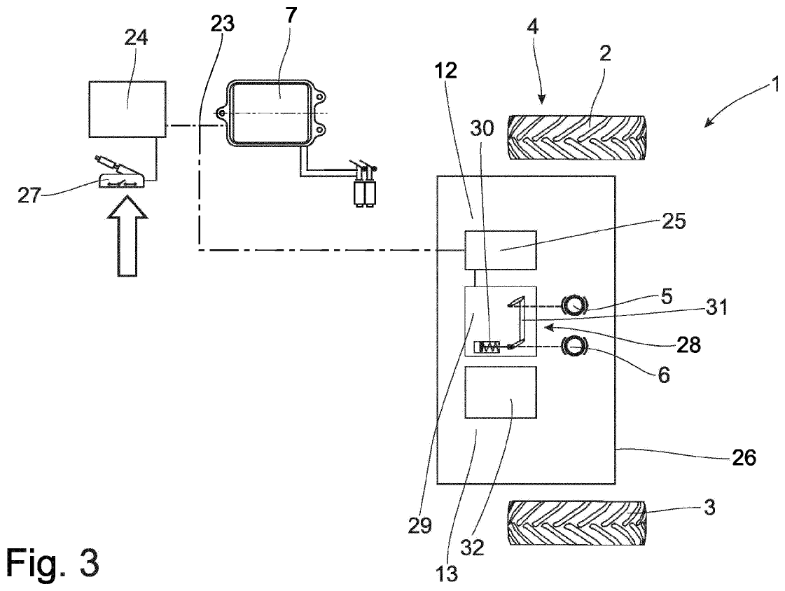

FIG. 3 shows a further state of the brake system 1, with FIG. 3 showing the situation in which the actuating device 27 is actuated by the driver and the auxiliary brake system 28 is operated as a parking brake. A respective degree of actuation of the actuating device 27 is detected by the control unit 24 and transmitted via the CAN bus 23 to the control unit 25, which then actuates the auxiliary brake actuator 29 in order to bring about actuation of the braking devices 5 and 6 via the bridge 31 via the auxiliary brake actuator 29 corresponding to the degree of actuation of the actuating device 27. As the degree of actuation of the actuating device 27 increases, the control unit 25 initiates increasing pressure relief of the fluid cylinder 30.

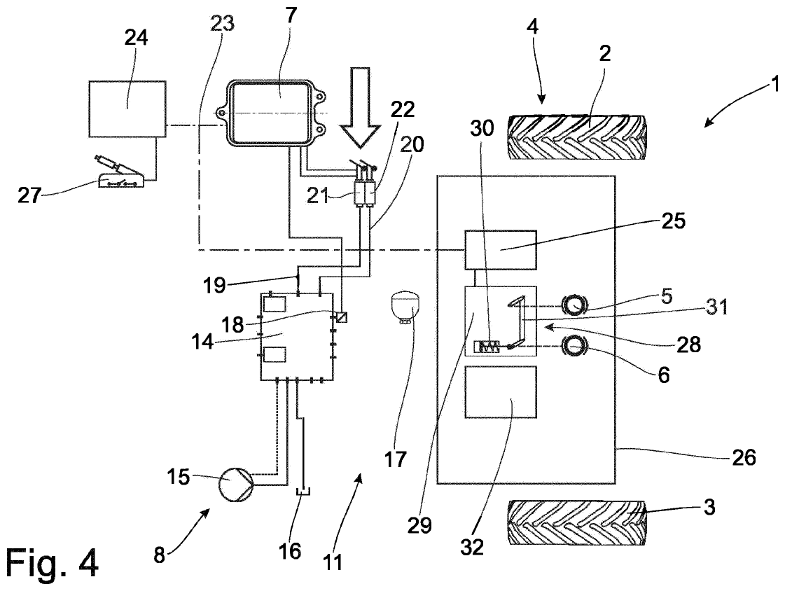

Finally, FIG. 4 shows the state of the brake system 1 in emergency operation due to an at least partial failure of the service brake system 8. The reason for the failure of the service brake system 8 could be a failure of the pressure source 15, leaks in the area of lines 12 and 13 or a failure of one or both service brake actuators 9 and 10. The first two reasons for failure in particular are detected by the control unit 7 by means of the pressure sensor 18, wherein the control unit 7 then initiates emergency operation when it detects that the fluid pressure in the brake circuit 11 is too low. Preferably, this is also indicated to the driver visually by means of a warning light and/or acoustically via a warning signal.

As a special feature, when the brake actuating devices 21 and 22 are actuated, the control unit 7 then automatically ensures that the braking of the vehicle wheels 2 and 3 is brought about as specified by the driver at the brake actuating devices 21 and 22. For this purpose, the control unit 7 initiates actuation of the auxiliary brake actuator 29 via the control unit 25 by means of the CAN bus 23, wherein actuation of the braking devices 5 and 6 is implemented via the auxiliary brake actuator 29 at the brake actuating devices 21 and 22 in accordance with the driver's specification. The control unit 7 detects the degree of actuation of the brake actuating devices 21 and 22, wherein the control unit 7 causes the fluid cylinder 30 of the auxiliary brake actuator 29 to be increasingly depressurized as the degree increases by means of the control unit 25. Ultimately, in emergency mode, a braking command from the driver at the brake actuating devices 21 and 22 is automatically converted into a required braking of the vehicle wheels 2 and 3 of the vehicle axle 4 by means of the auxiliary brake system 28.

As a result, if there is only a partial pressure failure in the service brake system 8, the brake request is automatically calculated in such a way that only a missing difference to the driver's request is fed in via the auxiliary brake system 28. The braking force applied via the auxiliary brake system 28 is mechanically added to the forces generated by the residual pressure in the service brake system 8 via the service brake actuators 9 and 10. This is done automatically and dynamically. Even if the pressure in the service brake system 8 continues to drop during braking, the compensating brake request to the auxiliary brake system 28 is automatically readjusted. In the event of a complete pressure failure in the service brake system 8, this control ensures that 100% of the driver's braking request is sent to the auxiliary brake system 28.

By means of a method for operating a brake system according to the invention, reliable braking of a commercial vehicle can nevertheless be achieved with a compact design in the event of at least partial failure of a service brake system.

### LIST OF REFERENCE NUMERALS

1 Brake system
2 Vehicle wheel
3 Vehicle wheel
4 Vehicle axle
5 braking device
6 braking device
7 Control unit
8 Operating brake system
9 Operating brake actuator
10 Operating brake actuator
11 Brake circuit
12 Line
13 Line
14 Valve block
15 Pressure source
16 Tank
17 Pressure accumulator
18 Pressure sensor
19 Line
20 Line
21 Brake actuating device
22 Brake actuating device
23 CAN bus
24 Control unit
25 Control unit
26 Transmission
27 Actuating device
28 Auxiliary brake system
29 Auxiliary brake actuator
30 Fluid cylinders
31 Bridge
32 Pressure source

1-15. (canceled)

16. A method for operating a brake system (1) of a commercial vehicle, wherein the brake system (1) has a service brake system (8), an auxiliary brake system (28), and braking devices (5, 6) for vehicle wheels (2, 3) of the commercial vehicle, the method comprising:
actuating at least one associated service brake actuator (9, 10) in the service brake system (8);
actuating at least one brake actuating device (21, 22) in normal operation, thereby actuating respective associated braking devices (5, 6) corresponding to the at least one brake actuating device (21, 22);
initiating, via at least one control device (25), actuation of at least one of the braking devices (5, 6) in the auxiliary brake system (28) by activating at least one auxiliary brake actuator (29); and
detecting an at least partial failure of the service brake system;
carrying out an emergency operation in response to detecting the at least partial failure, the emergency operation including:
accessing, by the at least one control unit (7), the auxiliary brake actuator (29);
detecting actuation of the at least one brake actuating device (21, 22); and
adjusting, by the at least one control unit (7), actuation of the at least one braking device (5, 6) by means of the auxiliary brake actuator (29), wherein the at least one braking device is actuated to a degree of full actuation of the at least one brake actuating device (21, 22).

17. The method according to claim 16, wherein the emergency operation further includes:
determining a required braking torque based on the degree of full actuation of the at least one brake actuating device (21, 22); and
using the required braking torque to set the actuation of the at least one auxiliary brake actuator (29).

18. The method according to claim 16, wherein detecting the at least partial failure includes detecting an at least partial failure of a pressure source (15) connected to the at least one associated service brake actuator (9, 10).

19. The method according to claim 18, wherein detecting the at least partial failure of the pressure source includes:
detecting, when detecting actuation of the at least one actuating device (21, 22), an at least partially low pressure supply to the at least one associated service brake actuator (9, 10).

20. The method according to claim 19, wherein detecting the at least partially low pressure supply is performed using a pressure sensor (18).

21. The method according to claim 16, wherein actuating the at least one auxiliary brake actuator (29) is initiated by a brake control unit and comprises:
transmitting data in a data transmission system between the brake control unit (7) and a transmission control unit; and
actuating the auxiliary brake actuator (29) by the transmission control unit in accordance with a specification of the brake control unit.

22. The method according to claim 16, wherein in the auxiliary brake system (28), actuating the at least one braking device (5, 6) is carried out by relieving the pressure in each at least one auxiliary brake actuator (29) from a fluid cylinder (30) which is equipped with an actuating piston preloaded into an actuating position.

23. A brake control device (7), configured to:
initiate activation of at least one auxiliary brake actuator (29) in an auxiliary brake system (28) of a brake system (1) of a commercial vehicle in order to actuate at least one braking device (5, 6) of a respective vehicle wheel (2, 3);
detect an at least partial failure of a service brake system (8) of the brake system (1);
initiate emergency operation in response to detecting the at least partial failure of the service brake system (8) of the brake system (1);
detect actuation of at least one brake actuating device (21, 22) of the service brake system; and
access the at least one auxiliary brake actuator (29) in the course of the emergency operation, thereby initiating actuation of the at least one braking device (5, 6) via the auxiliary brake actuator (29) oriented to a degree of actuation of the at least one brake actuating device (21, 22).

24. The control device (7) according to claim 23, further configured to carry out a method according to claim 16.

25. A brake system (1) for a commercial vehicle having a service brake system (8), an auxiliary brake system (28), and braking devices (5, 6) for vehicle wheels of the commercial vehicle, and the brake control device according to claim 23, the brake system comprising:
at least one service brake actuator (9, 10);
at least one brake actuating device (21, 22), via which at least one associated service brake actuator (9, 10) can be actuated when the at least one brake actuating device (21, 22) is actuated in normal operation;
wherein the at least one associated service brake actuator (9, 10) is configured to actuate the respectively associated braking device (5, 6) corresponding to the actuation of the at least one brake actuating device (21, 22) when actuated in normal operation; and
wherein the auxiliary brake system (28) has an auxiliary brake actuator (29) which can be actuated via the at least one control unit (7, 25) and configured to actuate at least one of the braking devices (5, 6) when actuated.

26. The brake system (1) according to claim 25, further configured to perform the method of claim 16.

27. The brake system (1) according to claim 26, comprising:
a first control unit (7),
a second control unit (25)
a data transmission system connecting the first control unit and the second control unit (25); is connected in a data transmission system to a second control unit (25), via which the auxiliary brake actuator (29) can be controlled.

28. The brake system (1) according to claim 27, wherein the first control unit is configured as a brake control unit and the second control unit is configured as a transmission control unit.

29. The brake system (1) according to claim 25, wherein the auxiliary brake actuator (29) has a fluid cylinder (30) with an actuating piston which is biased into an actuating position, wherein the actuating piston can be transferred into an opening position by pressurizing the fluid cylinder (30) with fluid, in which the actuation of the at least one braking device (5, 6) via the auxiliary brake actuator (29) is cancelled.

30. The brake system (1) according to claim 25, wherein, in the service brake system (8), the at least one associated service brake actuator (9, 10) is arranged in a respective brake circuit (11), in which, in normal operation, control of the respective associated service brake actuator (9, 10) takes place as a function of the actuation of the at least one brake actuating device (21, 22).

31. The brake system (1) according to claim 25, wherein in the service brake system (8) in at least one brake circuit (11), in which the service brake actuators (9, 10) can be controlled, a sensor system is provided, via which a pressure of fluid of the at least one brake circuit (11) can be monitored.

32. A commercial vehicle with a brake system, the brake system comprising:
a service brake system (8);
an auxiliary brake system (28);
braking devices (5, 6) for vehicle wheels of the commercial vehicle;
the brake control device according to claim 23;
at least one service brake actuator (9, 10);
at least one brake actuating device (21, 22), via which at least one associated service brake actuator (9, 10) can be actuated when the at least one brake actuating device (21, 22) is actuated in normal operation;
wherein the at least one associated service brake actuator (9, 10) is configured to actuate the respectively associated braking device (5, 6) corresponding to the actuation of the at least one brake actuating device (21, 22) when actuated in normal operation; and
wherein the auxiliary brake system (28) has an auxiliary brake actuator (29) which can be actuated via the at least one control unit (7, 25) and configured to actuate at least one of the braking devices (5, 6) when actuated.

33. The commercial vehicle of claim 32 configured as an agricultural vehicle.
